(19) United States
(12) Patent Application Publication
(10) Pub. No.: US 2025/0102975 A1
(43) Pub. Date: Mar. 27, 2025

(54) FIXING DEVICE AND IMAGE FORMING APPARATUS

(71) Applicant: FUJIFILM Business Innovation Corp., Tokyo (JP)

(72) Inventors: Shogo KAMIYA, Kanagawa (JP); Shingo Akiyama, Kanagawa (JP); Kotaro Araki, Kanagawa (JP)

(73) Assignee: FUJIFILM Business Innovation Corp., Tokyo (JP)

(21) Appl. No.: 18/438,038

(22) Filed: Feb. 9, 2024

(30) Foreign Application Priority Data
Sep. 26, 2023 (JP) 2023-162669

(51) Int. Cl. G03G 15/20

(52) U.S. Cl. CPC G03G 15/2032; G03G 15/2064; G03G 2215/2038

(57) ABSTRACT

A fixing device includes: a fixing member to be used in fixing an image on a recording medium; a rotatable member pressed against the fixing member while being allowed to rotate, the rotatable member cooperating with the fixing member in such a manner as to form a pressurization part where the recording medium is to be pressurized; and a transmission unit configured to transmit a rotational driving force to the rotatable member. The rotatable member is movable in a toward-and-away direction relative to the fixing member. The toward-and-away direction of the rotatable member is different from a direction in which the driving force transmitted by the transmission unit acts.

### CROSS-REFERENCE TO RELATED APPLICATIONS

This application is based on and claims priority under 35 USC 119 from Japanese Patent Application No. 2023-162669 filed Sep. 26, 2023.

### BACKGROUND

### (i) Technical Field

The present disclosure relates to a fixing device and an image forming apparatus.

### (ii) Related Art

A fixing device disclosed in Japanese Unexamined Patent Application Publication No. 2014-44257, for example, includes a fixing rotatable body having an endless shape and configured to fix toner to a recording medium by heating the toner while rotating, a pressurization rotatable body configured to nip and pressurize the toner and the recording medium in cooperation with the fixing rotatable body, and a support provided at a contact part between the fixing rotatable body and the pressurization rotatable body and supporting the fixing rotatable body from the inner side of the fixing rotatable body such that the peak pressure at the exit, for the recording medium, of the contact part is lower than or equal to the peak pressure at the entrance of the contact part.

### SUMMARY

Here, let us discuss a case where a rotatable member is pressed against a fixing member to be used in fixing an image on a recording medium and cooperates with the fixing member in such a manner as to form a pressurization part where the recording medium is to be pressurized, and the rotatable member is movable in a toward-and-away direction relative to the fixing member. When a rotational driving force transmitted to the rotatable member causes the rotatable member to move in the toward-and-away direction relative to the fixing member, the movement may influence the fixing of the image on the recording medium.

Aspects of non-limiting embodiments of the present disclosure relate to a configuration in which the influence that may be brought upon the fixing of an image on a recording medium is less than in a configuration in which a rotational driving force transmitted to a rotatable member causes the rotatable member to move in a toward-and-away direction relative to a fixing member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including: a fixing member to be used in fixing an image on a recording medium; a rotatable member pressed against the fixing member while being allowed to rotate, the rotatable member cooperating with the fixing member in such a manner as to form a pressurization part where the recording medium is to be pressurized; and a transmission unit configured to transmit a rotational driving force to the rotatable member, wherein the rotatable member is movable in a toward-and-away direction relative to the fixing member, and wherein the toward-and-away direction of the rotatable member is different from a direction in which the driving force transmitted by the transmission unit acts.

### BRIEF DESCRIPTION OF THE DRAWINGS

Exemplary embodiments of the present disclosure will be described in detail based on the following figures, wherein:

FIG. 1 illustrates an image forming apparatus according to a general embodiment;

FIG. 2 illustrates a configuration of a fixing instrument according to the general embodiment;

FIG. 3 illustrates a fixing instrument according to a first exemplary embodiment;

FIG. 4 illustrates a transmission unit according to the first exemplary embodiment;

FIG. 5 illustrates a fixing instrument according to a second exemplary embodiment;

FIG. 6 illustrates the fixing instrument according to the second exemplary embodiment; and

FIG. 7 illustrates a transmission unit according to the second exemplary embodiment.

### DETAILED DESCRIPTION

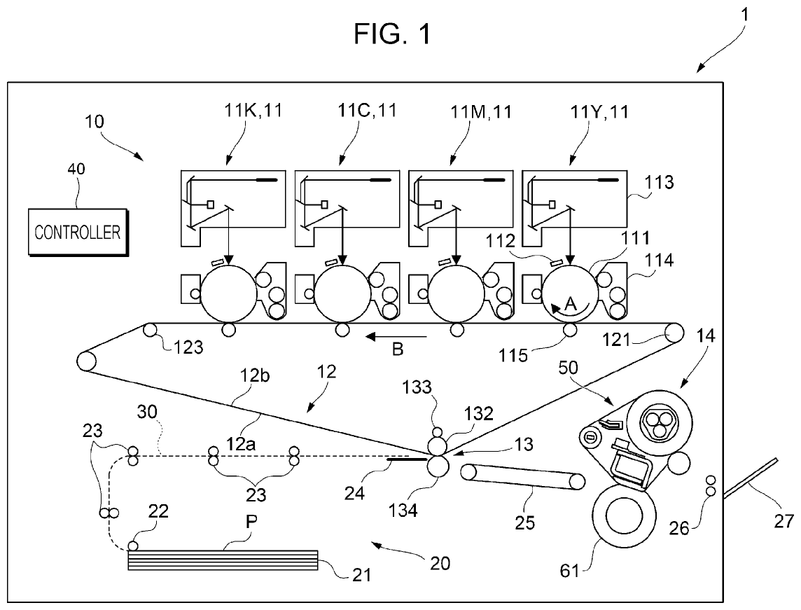

FIG. 1 illustrates an image forming apparatus 1 according to a general embodiment.

The image forming apparatus 1 illustrated in FIG. 1 is an apparatus configured to form an image on a sheet P. The image forming apparatus 1 includes an image forming section 10, a sheet transporting section 20, and a controller 40.

The image forming section 10 includes image forming units 11, an intermediate transfer belt 12, a second-transfer unit 13, and a fixing instrument 14.

In the general embodiment, the image forming units 11 are four image forming units 11Y, 11M, 11C, and 11K, which are provided for respective toners having four respective colors of yellow (Y), magenta (M), cyan (C), and black (K).

The image forming units 11Y, 11M, 11C, and 11K are arranged side by side in a direction in which the intermediate transfer belt 12 rotates, and are configured to electrophotographically form respective toner images.

The image forming units 11Y, 11M, 11C, and 11K each include a photoconductor drum 111, a charging unit 112, an exposure unit 113, a developing unit 114, and a first-transfer unit 115.

The image forming units 11Y, 11M, 11C, and 11K are configured to form respective toner images in the respective colors of Y, M, C, and K and to transfer the toner images to the intermediate transfer belt 12. Thus, the toner images in the respective colors of Y, M, C, and K are superposed one on top of another on the intermediate transfer belt 12 into a toner image.

Specifically, the photoconductor drums 111 are rotated in the direction of arrow A at a predetermined speed. On the peripheral surfaces of the photoconductor drums 111 are to be formed respective electrostatic latent images.

The charging units 112 charge the peripheral surfaces of the respective photoconductor drums 111 to a predetermined potential.

The exposure units 113 radiate respective light beams to the charged peripheral surfaces of the respective photoconductor drums 111, thereby forming respective electrostatic latent images on the peripheral surfaces of the photoconductor drums 111.

The developing units 114 cause the respective toners to adhere to the respective electrostatic latent images formed on the peripheral surfaces of the photoconductor drums 111, thereby forming respective toner images.

The first-transfer units 115 transfer the respective toner images formed on the peripheral surfaces of the photoconductor drums 111 to the intermediate transfer belt 12.

The first-transfer units 115 receive a voltage of a polarity opposite to the polarity for charging the toners. With the voltage, the toner images formed on the peripheral surfaces of the photoconductor drums 111 are electrostatically attracted to the intermediate transfer belt 12 sequentially in such a manner as to be superposed one on top of another on the intermediate transfer belt 12 into one color toner image.

The intermediate transfer belt 12 is supported by a plurality of roll-type members. The intermediate transfer belt 12 has an endless shape and is to be rotated circularly in the direction of arrow B. The intermediate transfer belt 12 has an outer peripheral surface 12a and an inner peripheral surface 12b.

The intermediate transfer belt 12 is intended to transport the toner image. In the general embodiment, the toner image is to be formed on the outer peripheral surface 12a of the intermediate transfer belt 12 and to be transported to the second-transfer unit 13 with the rotation of the intermediate transfer belt 12.

In the general embodiment, a driving roll 121 is employed as one of the roll-type members provided on the inner side of the intermediate transfer belt 12 and is configured to be driven by a motor (not illustrated) in such a manner as to move the intermediate transfer belt 12. Furthermore, an idle roll 123 and a backup roll 132 are employed as other ones of the roll-type members and support the intermediate transfer belt 12.

The above roll-type members are rotatable and are pressed against the inner peripheral surface 12b of the intermediate transfer belt 12.

The sheet transporting section 20 includes a sheet container 21, in which a plurality of sheets P are stacked; and a pickup roll 22, which is configured to pick up a sheet P from the sheet container 21 and to transport the sheet P.

The sheet transporting section 20 further includes transporting rolls 23, with which the sheet P picked up by the pickup roll 22 is transported along a sheet transport path 30; and a sheet guide 24, with which the sheet P transported by the transporting rolls 23 is guided to the second-transfer unit 13.

The sheet transporting section 20 further includes a transporting belt 25, with which the sheet P having undergone a second-transfer process is transported to the fixing instrument 14; and a sheet guide 26, with which the sheet P having undergone a fixing process is guided to a sheet output part 27.

The second-transfer unit 13 includes a second-transfer roll 134, which is provided in contact with the outer peripheral surface 12a of the intermediate transfer belt 12; and the backup roll 132, which is provided facing the inner peripheral surface 12b of the intermediate transfer belt 12 and serves as a counter electrode for the second-transfer roll 134.

In the general embodiment, the backup roll 132 is provided with a power feeding roll 133, which is made of metal and is configured to apply a second-transfer bias to the backup roll 132.

In the second-transfer unit 13 configured as above, the toner image transported to the second-transfer unit 13 by the intermediate transfer belt 12 is transferred to the sheet P transported to the second-transfer unit 13.

The fixing instrument 14 is located on the downstream side relative to the second-transfer unit 13 in the direction of transport of the sheet P. The fixing instrument 14 includes a fixing-belt module 50, which includes a heat source; and a pressure roll 61, which is provided facing the fixing-belt module 50.

When the sheet P having passed through the second-transfer unit 13 is transported into the part between the fixing-belt module 50 and the pressure roll 61, the toner image that is yet to be fixed on the sheet P is melted and is fixed on the sheet P. Thus, an image composed of the toner image is obtained on the sheet P.

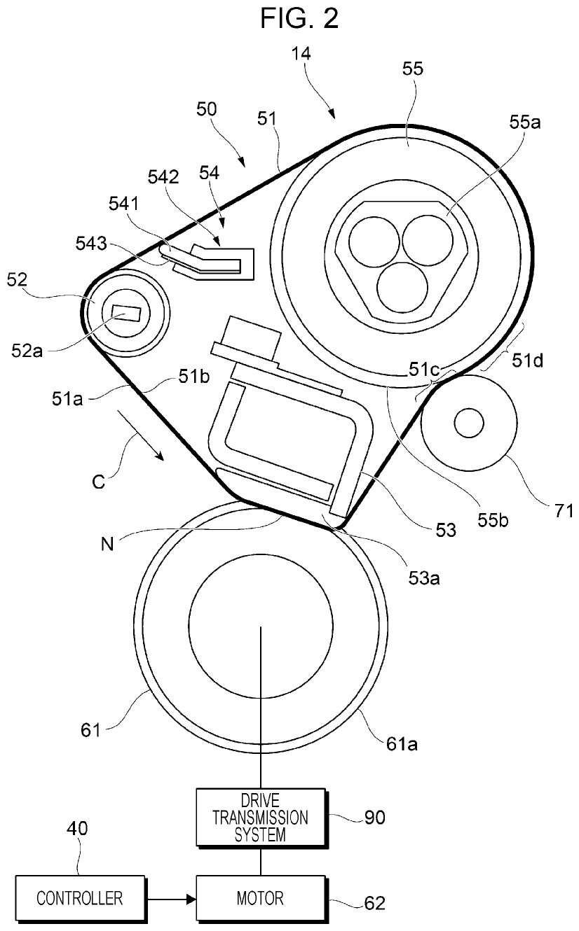

FIG. 2 illustrates a configuration of the fixing instrument 14 according to the general embodiment.

As illustrated in FIG. 2, the fixing instrument 14 according to the general embodiment includes the above-mentioned fixing-belt module 50, which includes a fixing belt 51; and the above-mentioned pressure roll 61, which is provided in contact with the outer peripheral surface, 51a, of the fixing belt 51.

The fixing-belt module 50 includes the above-mentioned fixing belt 51, which is to be made to undergo a circular motion in the direction of arrow C; and a first stretch roll 52, which stretches the fixing belt 51 from the inner side of the fixing belt 51. The fixing-belt module 50 further includes a second stretch roll 55, which stretches the fixing belt 51 from the inner side of the fixing belt 51 at a position on the upstream side relative to the first stretch roll 52 in the direction of arrow C. The fixing-belt module 50 further includes a pressing unit 53, which is located on the downstream side relative to the first stretch roll 52 in the direction of arrow C and includes a pad 53a. The pad 53a is intended to form a nip part N by pressing the fixing belt 51 against the pressure roll 61.

In the fixing instrument 14, a part of the outer peripheral surface, 61a, of the pressure roll 61 located across from the pressing unit 53 is pressed against a part of the outer peripheral surface 51a of the fixing belt 51 that is in contact with the pressing unit 53, whereby the nip part N is formed. The nip part N where the outer peripheral surface 61a of the pressure roll 61 and the fixing belt 51 are in contact with each other is regarded as a passing part through which the sheet P having a toner image formed thereon passes while being pressurized and heated.

The sheet P approaching the nip part N has a toner-image-formed surface on which a toner image has been formed. In the general embodiment, the sheet P approaches the nip part N with the toner-image-formed surface facing upward. Therefore, in the general embodiment, the toner-image-formed surface of the sheet P comes into contact with the fixing belt 51.

In the general embodiment, the pressure roll 61 is driven to rotate by a motor 62, and the fixing belt 51 undergoes a circular motion by following the pressure roll 61. That is, the fixing belt 51 undergoes a circular motion (rotates circularly) in the direction of arrow C by receiving a driving force from the rotating pressure roll 61.

More specifically, a rotational driving force is generated by the motor 62 and is transmitted to the pressure roll 61 through a drive transmission system 90. The driving of the motor 62 is controlled by the controller 40.

The first stretch roll 52 and the second stretch roll 55 are supported in a rotatable manner with the fixing belt 51 being wrapped therearound at the respective positions that are apart from each other, thereby supporting the fixing belt 51 while allowing the fixing belt 51 to undergo a circular motion. The pressing unit 53 is located across the fixing belt 51 from the pressure roll 61 and presses, without rotating, the fixing belt 51 against the pressure roll 61. The pressure roll 61 includes an elastically deformable layer on the outer peripheral side thereof. The pressing unit 53 is positioned in contact with the pressure roll 61 with the fixing belt 51 in between, whereby the pressure roll 61 is compressed at the nip part N. In the general embodiment, the sheet P is to be nipped from both sides thereof by the pressure roll 61 and the pressing unit 53 so that a pressure is to be applied to the sheet P.

The first stretch roll 52 is provided thereinside with a heater 52a. The second stretch roll 55 is also provided thereinside with a heater 55a. The heaters 52a and 55a are halogen heaters, for example. Heat generated by the heater 52a heats the first stretch roll 52, and heat generated by the heater 55a heats the second stretch roll 55. The heat generated by the first stretch roll 52 and the second stretch roll 55 heats the fixing belt 51.

In the general embodiment illustrated in FIG. 2, the fixing belt 51 is wrapped around the outer peripheral surface of the first stretch roll 52 by a length about a quarter of the circumference of the first stretch roll 52. The fixing belt 51 is also wrapped around the outer peripheral surface, 55b, of the second stretch roll 55 by a length about a half or greater of the circumference of the second stretch roll 55. Thus, heat of an amount generated by the heaters 52a and 55a is applied to the fixing belt 51.

The fixing-belt module 50 includes a liquid applicator 54, which is located between the first stretch roll 52 and the second stretch roll 55 and is configured to apply oil to the inner peripheral surface, 51b, of the fixing belt 51. The liquid applicator 54 includes an oil-impregnated member 541, which is in contact with the inner peripheral surface 51b of the fixing belt 51; a housing 542, which holds the oil-impregnated member 541; and a supporting member 543, which supports a part, including the tip, of the oil-impregnated member 541 from a side across the oil-impregnated member 541 from the fixing belt 51.

The oil-impregnated member 541 is a piece of nonwoven fabric made of heat-resistant fibers and is impregnated with oil. Examples of heat-resistant fibers include polytetrafluoroethylene (PTFE). The oil applied to the inner peripheral surface 51b of the fixing belt 51 by the oil-impregnated member 541 reduces the coefficient of friction between the pressing unit 53 and the fixing belt 51 and thus reduces the wear of the fixing belt 51.

The fixing-belt module 50 includes an upstream cleaning roll 71, which is intended to clean the outer peripheral surface 51a of the fixing belt 51.

The upstream cleaning roll 71 serves as a cleaning member intended to clean the outer peripheral surface 51a of the fixing belt 51 and is, more specifically, configured to remove unwanted matter and the like adhered to the outer peripheral surface 51a of the fixing belt 51 from a part of the fixing belt 51 that has passed through the nip part N.

The upstream cleaning roll 71 is located on the upstream side relative to the second stretch roll 55 at such a position as to nip the fixing belt 51 in cooperation with the second stretch roll 55. In other words, the upstream cleaning roll 71 is located at an approach part of the second stretch roll 55 in such a manner as to bring a part of the fixing belt 51 that is apart from the second stretch roll 55 into contact with the second stretch roll 55.

The upstream cleaning roll 71 according to the general embodiment has a surface formed of nonwoven fabric or felt, or of a porous member. The upstream cleaning roll 71 according to the general embodiment is a follower roll configured to rotate by being in contact with the fixing belt 51 that is undergoing a circular motion.

As illustrated in FIG. 2, the part of the fixing belt 51 that has passed through the nip part N is then nipped between the upstream cleaning roll 71 and the second stretch roll 55, thereby deforming into an S shape. More specifically, the fixing belt 51 deforms in such a manner as to have an inwardly protruding part 51c and an outwardly protruding part 51d, which are continuous with each other. The inwardly protruding part 51c protrudes on the side of the inner peripheral surface 51b of the fixing belt 51 while running along the upstream cleaning roll 71. The outwardly protruding part 51d protrudes on the side of the outer peripheral surface 51a of the fixing belt 51 while running along the second stretch roll 55.

The inwardly protruding part 51c is formed at the approach part, for the fixing belt 51, of the second stretch roll 55 with the deformation of the fixing belt 51 pressed by the upstream cleaning roll 71.

With such an S-shaped deformation, the locus of the fixing belt 51 is defined at the approach part, for the fixing belt 51, of the second stretch roll 55 with the pressing of the fixing belt 51 by the upstream cleaning roll 71.

Note that the sheet P is an exemplary recording medium, the pressing unit 53 or the fixing-belt module 50 is an exemplary fixing member, the pressure roll 61 is an exemplary rotatable member, the nip part N is an exemplary pressurization part, the fixing belt 51 is an exemplary annular member, and the fixing instrument 14 is an exemplary fixing device.

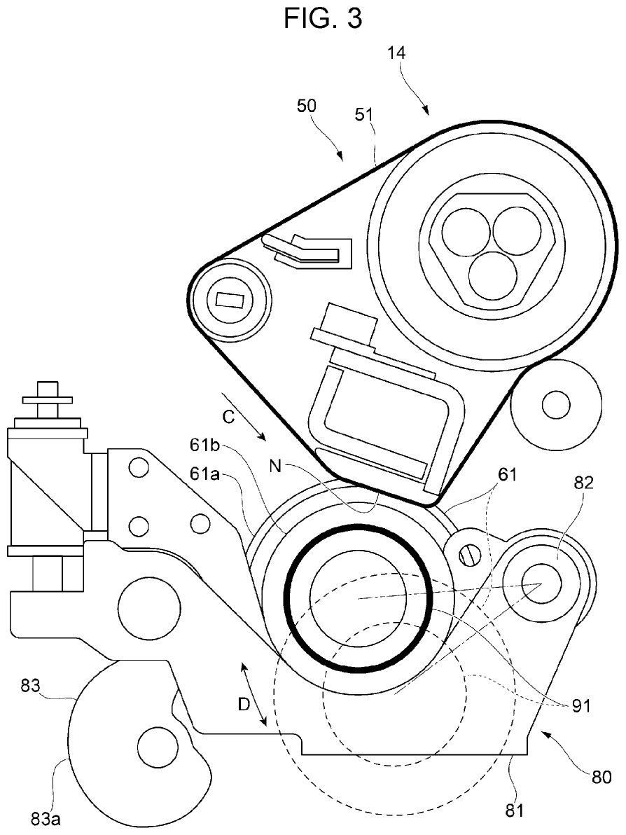

In the general embodiment, the pressing unit 53 (see FIG. 2) is fixed for the formation of the nip part N in the fixing instrument 14 (see FIG. 2) and for the stable traveling of the sheet P (see FIG. 1). To keep the nipping load at a predetermined value by using the fixed pressing unit 53, the pressure roll 61 (see FIG. 2) needs to be urged by using, for example, a spring. To efficiently generate the nipping load by using the pressure roll 61 and cause the pressure roll 61 to move in the direction of arrow D (see FIG. 3, for example), which is a toward-and-away direction relative to the fixed pressing unit 53, a below-described moving mechanism 80 needs to be positioned with a pivot 82 (see FIG. 3, for example) being located on the upstream side or the downstream side relative to the pressure roll 61 in the direction of transport of the sheet P. Furthermore, if the fixed pressing unit 53 is employed, the fixing belt 51 needs to be moved by using the pressure roll 61. Furthermore, if the motion of the pressure roll 61 is based on a latch mechanism, the accuracy between gear axes may be maintained by employing a configuration in which the driving force generated by the motor 62 (see FIG. 2) is inputted to a gear configured to rotate about the below-described pivot 82.

However, if the configuration in which the driving force generated by the motor 62 is inputted to a gear configured to rotate about the pivot 82 is employed, the reaction force generated in response to the driving force changes the nipping load generated at the nip part N, bringing an adverse influence upon the fixing of an image on the sheet P.

Hence, the general embodiment employs a configuration in which the nipping load does not change at the generation of the reaction force, thereby reducing the change in the nipping load that may be caused by the reaction force generated in response to the driving force of the motor 62.

Now, a first exemplary embodiment and a second exemplary embodiment will be described.

### First Exemplary Embodiment

FIG. 3 illustrates a fixing instrument 14 according to a first exemplary embodiment.

The fixing instrument 14 according to the first exemplary embodiment includes a moving mechanism 80, which is capable of moving a pressure roll 61 in a toward-and-away direction relative to a fixing-belt module 50. The fixing-belt module 50 is the same as the one illustrated in FIG. 2, and some description thereof is omitted.

### Moving Mechanism 80

As illustrated in FIG. 3, the moving mechanism 80 according to the first exemplary embodiment includes a body 81, a pivot 82, and a cam member 83.

The body 81 is rotatable about the pivot 82. The pivot 82 is not displaceable relative to the fixing-belt module 50. The body 81 supports the pressure roll 61 at rotation shafts 61b, which are provided at the two respective ends of the pressure roll 61, while allowing the rotation of the pressure roll 61.

Therefore, the pressure roll 61 supported by the body 81 is movable with the movement of the body 81 in the direction of arrow D. That is, the pressure roll 61 is movable toward and away from the fixing-belt module 50.

The direction of arrow D is an exemplary toward-and-away direction in which the pressure roll 61 is movable toward and away from the fixing-belt module 50.

The cam member 83 is a disc-type member having a cam surface 83a. The distance between the cam surface 83a and the rotation axis of the cam member 83 varies with the position of the cam surface 83a in the peripheral direction. The cam member 83 is to be driven by a motor (not illustrated) while the position thereof in the peripheral direction is controlled. The motor (not illustrated) may be a stepping motor, whose position is controllable.

The cam member 83 is located below the body 81. A part of the body 81 is in contact with the cam surface 83a, whereby the body 81 is movable up and down about the pivot 82 with the rotation of the cam member 83.

Accordingly, the pressure roll 61 supported by the body 81 is displaceable from a position in contact with the fixing-belt module 50 as illustrated by solid lines to a position away from the fixing-belt module 50 as illustrated by broken lines, and vice versa. Thus, the pressure roll 61 is movable with the aid of the cam member 83 in the toward-and-away direction relative to the fixing-belt module 50.

### Drive Transmission System 90

The first exemplary embodiment employs a transmission unit 91 as the drive transmission system 90. The transmission unit 91 is coaxially connected to one of the rotation shafts 61b of the pressure roll 61. That is, the pressure roll 61 receives the rotational driving force of the motor 62 (see FIG. 2) on an axis that is coaxial with the pressure roll 61.

Therefore, no moment is generated in the direction of arrow D defined about the pivot 82.

The transmission unit 91 is located across the pressure roll 61 from the pressing unit 53.

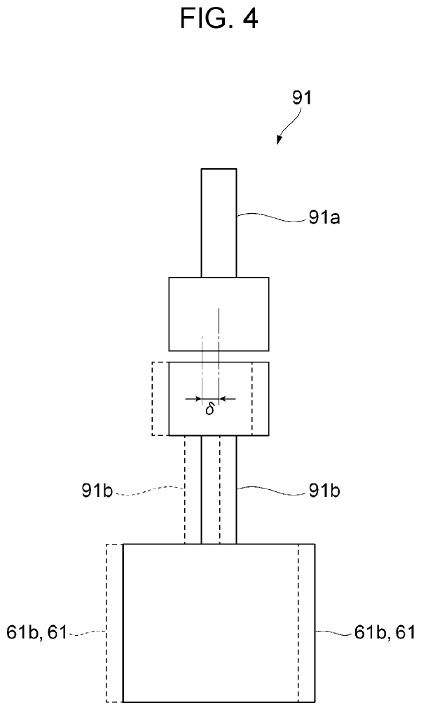

FIG. 4 illustrates the transmission unit 91 according to the first exemplary embodiment.

As illustrated in FIG. 4, the transmission unit 91 is a coupling or a shaft coupling. Specifically, the transmission unit 91 includes a driving shaft 91a, which faces the motor 62 (see FIG. 2); and a follower shaft 91b, which is connected to the rotation shaft 61b of the pressure roll 61.

More specifically, the transmission unit 91 is a flexible coupling configured to allow the axial deflection and angular deflection between the driving shaft 91a and the follower shaft 91b and the runout of the driving shaft 91a and the follower shaft 91b. Even if, for example, the follower shaft 91b is displaced from the position illustrated by the solid lines to the position illustrated by the broken lines with the movement of the pressure roll 61 in the direction of arrow D, the transmission unit 91 follows the displacement. The amount of displacement 8 in this case is, for example, about 3 mm, which is absorbable.

### Second Exemplary Embodiment

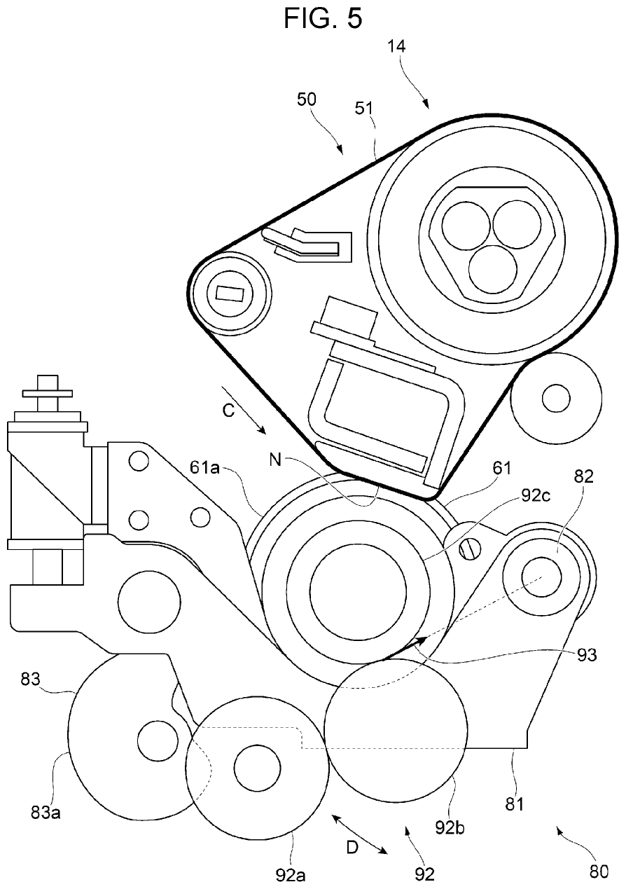

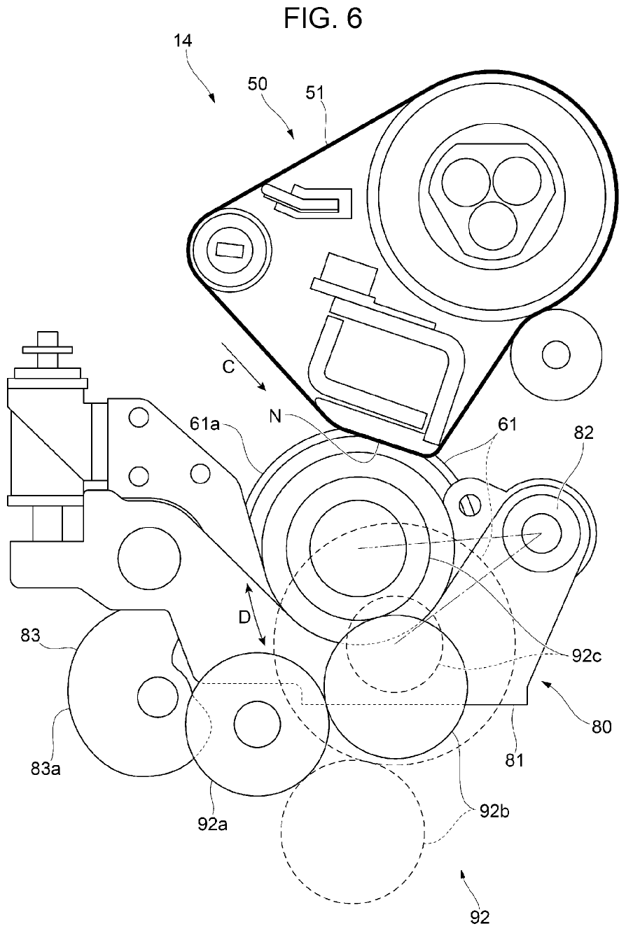

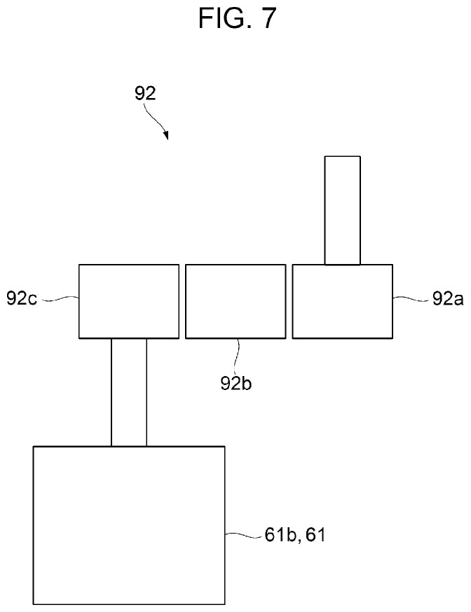

FIGS. 5 and 6 illustrate a fixing instrument 14 according to a second exemplary embodiment and also illustrate a moving mechanism 80. FIGS. 5 and 6 correspond to FIG. 3 illustrating the first exemplary embodiment. FIG. 7 illustrates a transmission unit 92 according to the second exemplary embodiment.

### Moving Mechanism 80

As illustrated in FIGS. 5 and 6, the moving mechanism 80 includes a body 81, a pivot 82, and a cam member 83. The moving mechanism 80 according to the second exemplary embodiment is the same as that of the first exemplary embodiment illustrated in FIG. 3. Therefore, relevant elements are denoted by corresponding ones of the reference signs used in the first exemplary embodiment and are not described herein.

### Drive Transmission System 90

As illustrated in FIGS. 5 to 7, the second exemplary embodiment employs a transmission unit 92 as the drive transmission system 90 (see FIG. 2). The transmission unit 92 is located across the pressure roll 61 from the pressing unit 53.

Specifically, as illustrated in FIG. 7 for example, the transmission unit 92 includes a driving gear 92a, to which the rotational driving force generated by the motor 62 (see FIG. 2) is to be inputted; a follower gear 92b, which is in mesh with the driving gear 92a; and a gear 92c, which is in mesh with the follower gear 92b and is provided at the end of the pressure roll 61. The driving gear 92a and the follower gear 92b are provided on the body 81 of the moving mechanism 80.

In the second exemplary embodiment, as illustrated in FIG. 5 or 6, the driving gear 92a, the follower gear 92b, and the gear 92c are each a spur gear in view of space reduction. Alternatively, any of the gears 92a to 92c may be a gear, such as a bevel gear, other than a spur gear.

The gear 92c is an exemplary spur gear that is coaxial with the rotation shaft of the rotatable member, the follower gear 92b is an exemplary gear that is in mesh with the spur gear, and the driving gear 92a is an exemplary driving gear. The body 81 is an exemplary fixed member.

As illustrated in FIG. 5, the transmission unit 92 is configured such that a reaction force 93 is generated toward the pivot 82 in response to the rotational driving force of the motor 62 (see FIG. 2) that is transmitted through the follower gear 92b to the gear 92c provided at the end of the pressure roll 61. More specifically, the direction in which the driving force transmitted by the transmission unit 92 acts is a direction toward the pivot 82 and is different from the direction of arrow D, which is the toward-and-away direction in which the pressure roll 61 is to be moved toward and away from the fixing-belt module 50. In other words, the direction of arrow D that is the toward-and-away direction of the pressure roll 61 is different from the direction in which the driving force transmitted by the transmission unit 92 acts.

Therefore, no moment is generated in the direction of arrow D defined about the pivot 82.

The direction of the reaction force 93 illustrated in FIG. 5 is a direction toward the center of the pivot 82, as illustrated by a broken line. More specifically, the direction of the reaction force 93 is determined by the pressure angle of a relevant one of the gears. The pressure angle is an angle formed between the line of radius of a gear that passes through a given point on a tooth face of the gear and a tangent to the tooth face. The gear transmits a force in a direction determined by the pressure angle.

As illustrated in FIG. 6, when the pressure roll 61 moves in the direction of arrow D relative to the fixing-belt module 50, the follower gear 92b is displaced in such a manner as to follow the gear 92c provided at the end of the pressure roll 61.

The driving gear 92a is not displaceable relative to the fixing-belt module 50.

Thus, in the transmission unit 92 according to the second exemplary embodiment, the follower gear 92b is kept in mesh with the gear 92c even when the pressure roll 61 moves away from the fixing-belt module 50. Hence, even when the pressure roll 61 is spaced away from the fixing-belt module 50, the pressure roll 61 is rotatable.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A fixing device comprising:
a fixing member to be used in fixing an image on a recording medium;
a rotatable member pressed against the fixing member while being allowed to rotate, the rotatable member cooperating with the fixing member in such a manner as to form a pressurization part where the recording medium is to be pressurized; and
a transmission unit configured to transmit a rotational driving force to the rotatable member,
wherein the rotatable member is movable in a toward-and-away direction relative to the fixing member, and
wherein the toward-and-away direction of the rotatable member is different from a direction in which the driving force transmitted by the transmission unit acts.
   (((2)))

The fixing device according to (((1))),
wherein the transmission unit is located across the rotatable member from the fixing member.
   (((3)))

The fixing device according to (((1))) or (((2))),
wherein the transmission unit includes a gear that is in mesh with a spur gear that is coaxial with a rotation shaft of the rotatable member.
   (((4)))

The fixing device according to (((3))),
wherein the gear is provided on a fixed member together with a driving gear that is in mesh with the gear, and
wherein the gear is kept in mesh with the spur gear even when the rotatable member moves away from the fixing member.
   (((5)))

The fixing device according to any one of (((1))) to (((4))), further comprising:
an annular member that is to be rotated and is provided around the fixing member and the rotatable member,
wherein the annular member is rotated with a driving force generated by the rotatable member.
   (((6)))

A fixing device comprising:
a fixing member to be used in fixing an image on a recording medium;
a rotatable member pressed against the fixing member while being allowed to rotate, the rotatable member cooperating with the fixing member in such a manner as to form a pressurization part where the recording medium is to be pressurized; and
a transmission unit configured to transmit a rotational driving force to the rotatable member,
wherein the rotatable member is movable in a toward-and-away direction relative to the fixing member, and
wherein the transmission unit is coaxially connected to a rotation shaft of the rotatable member.
   (((7)))

The fixing device according to (((6))),
wherein the transmission unit includes a coupling.
   (((8)))

An image forming apparatus comprising the fixing device according to (((1))).

(((9)))

An image forming apparatus comprising the fixing device according to (((6))).

What is claimed is:

1. A fixing device comprising:
a fixing member to be used in fixing an image on a recording medium;
a rotatable member pressed against the fixing member while being allowed to rotate, the rotatable member cooperating with the fixing member in such a manner as to form a pressurization part where the recording medium is to be pressurized; and
a transmission unit configured to transmit a rotational driving force to the rotatable member,
wherein the rotatable member is movable in a toward-and-away direction relative to the fixing member, and
wherein the toward-and-away direction of the rotatable member is different from a direction in which the driving force transmitted by the transmission unit acts.

2. The fixing device according to claim 1,
wherein the transmission unit is located across the rotatable member from the fixing member.

3. The fixing device according to claim 1,
wherein the transmission unit includes a gear that is in mesh with a spur gear that is coaxial with a rotation shaft of the rotatable member.

4. The fixing device according to claim 3,
wherein the gear is provided on a fixed member together with a driving gear that is in mesh with the gear, and
wherein the gear is kept in mesh with the spur gear even when the rotatable member moves away from the fixing member.

5. The fixing device according to claim 1, further comprising:
an annular member that is to be rotated and is provided around the fixing member and the rotatable member,
wherein the annular member is rotated with a driving force generated by the rotatable member.

6. A fixing device comprising:
a fixing member to be used in fixing an image on a recording medium;
a rotatable member pressed against the fixing member while being allowed to rotate, the rotatable member cooperating with the fixing member in such a manner as to form a pressurization part where the recording medium is to be pressurized; and
a transmission unit configured to transmit a rotational driving force to the rotatable member,
wherein the rotatable member is movable in a toward-and-away direction relative to the fixing member, and
wherein the transmission unit is coaxially connected to a rotation shaft of the rotatable member.

7. The fixing device according to claim 6,
wherein the transmission unit includes a coupling.

8. An image forming apparatus comprising the fixing device according to claim 1.

9. An image forming apparatus comprising the fixing device according to claim 6.
